(19) United States
(12) Patent Application Publication
(10) Pub. No.: US 2006/0136113 A1
(43) Pub. Date: Jun. 22, 2006

(54) System for improving engine performance and reducing emissions

(76) Inventors: James C. Juranitch, Oconomowoc, WI (US); Robert D. Olschefski, New Hudson, MI (US)

Correspondence Address: Gerald E McGlynn III;Bliss McGlynn, Suite 600, 2075 West Big Beaver Road, Troy, MI, 48084, US

(21) Appl. No.: 10/520,222

(22) PCT Filed: Jul. 2, 2003
(86) PCT No.: PCT/US03/20729

§ 371 Date: Oct. 27, 2005

Related U.S. Application Data
(60) Provisional application No. 60/393,648, filed on Jul. 2, 2002.

(51) Int. Cl. F02D 41/26; F02D 45/00

(52) U.S. Cl. 701/104; 701/114; 701/105; 701/115

(57) ABSTRACT

A method of correcting engine performance in response to assembly deviations includes the steps of measuring the physical characteristics of each cylinder of the engine, and storing the resulting data in the associated ECM. The engine is then operated in accordance with the stored data. The physical characteristics that are measured include, inter alia, a distance of axial displacement of each piston within its associated cylindrical bore; a timing characteristic of the camshaft; a timing of a fuel injection interval; the rate of fuel flow as a function of crankshaft angle of rotation, and a timing characteristic of the crankshaft. Some of the operating parameters that arc controlled during engine operation in response to the data stored in the ECM include, inter alia, the air:fuel ratio and the timing of a fuel injection interval for each piston. These corrections result in increased power, decreased emissions, better mileage, a smoother running engine, and less costly components.

### RELATIONSHIP TO OTHER APPLICATION

This application claims the benefit of Provisional Application for U.S. Letters Patent Ser. No. 60/393,648, filed Jul. 2, 2002.

### BACKGROUND OF THE INVENTION

1. Field of the Invention

This invention relates generally to arrangements and systems for improving the performance of Diesel engines while reducing emissions therefrom, and more particularly, to a system that monitors physical characteristics of a Diesel engine and effects electronic correction therefor.

2. Description of the Related Art

The Diesel engine manufacturing industry is under increasing pressure to reduce emissions, yet maintain or improve engine performance. The market for such engines is mature and competitive. It is another characteristic of the market that production capability of Diesel engines greatly exceeds demand in the current market. Customers demand high value and do not feel compelled to pay for reductions in emissions. In particular, customers are not willing to suffer reductions in engine performance or reliability, irrespective of the fact that the government has mandated that the emission of pollutants be reduced.

It is a characteristic of such engines that the Diesel cycle is a difficult and complex combustion process on which to reduce emissions. Nevertheless, the mandated emission standards are extremely strict, and simple, presently available after-treatments, such as catalytic conversion, are largely ineffective in reducing the emissions of Diesel engines.

It is, therefore, an object of this invention to provide a system for reducing Diesel engine emissions, without adversely affecting engine performance.

It is another object of this invention to provide a system for improving the performance of a Diesel engine, while achieving compliance with emissions standards mandated by the government.

### SUMMARY OF THE INVENTION

The foregoing and other objects are achieved by the invention described herein which provides a system for measuring assembly errors introduced during the Diesel engine manufacturing process. In a highly advantageous embodiment of the invention, the assembly errors are determined on a cylinder-by-cylinder basis. Data responsive to such errors is then relayed to an engine control module (ECM) burn station where corrective strategies are implemented electronically to effect reduction in engine emissions and enhance performance. It is to be understood that a simplified embodiment of the inventive arrangement can be implemented in factory service and engine rebuild facilities.

Some of the errors that are measured and for which correction is implemented hereunder relate to engine air flow, injection timing, compression variability, and piston crevice volume. One method of measuring these errors or offsets is by utilizing a drive system that attaches to an engine crank shaft in a production environment. The drive system very accurately and consistently rotates a four-stroke engine through a minimum of its 720° cycle. It is designed to have zero lash, and to read out its absolute location to a precision determined in hundredths of a degree at all times.

The second portion of the measurement arrangement is a measurement head that communicates with the firing deck of the engine, as well as its pistons, cams, oil galleries, fuel galleries, internal balancers, and other components. The measurement head has incorporated therein very accurate sensors that measure these engine components' absolute and relational positions on every engine at production line speeds.

In accordance with a first method aspect of the invention, there is provided a method of correcting engine performance in response to assembly deviations. The method includes the steps of:

measuring a physical characteristic of the engine; and

storing data responsive to the step of measuring in a computer.

In a specific illustrative embodiment of the invention there is further provided the step of operating the engine in response to the stored data. In a further embodiment, the stored data corresponds to deviation information responsive to deviation of a physical characteristic of the engine from a determined norm. During operation of the engine, an operating characteristic the engine is varied in response to the deviation information.

In an embodiment where the engine is an internal combustion engine having a plurality of cylinders, the computer is an engine control module, and the stored data has a plurality of data portions corresponding to the physical characteristics of respectively corresponding ones of the cylinders. There are provided the steps of operating each of the plurality of cylinders of the internal combustion engine in response to the respectively corresponding portions of the stored data, and the step of measuring a physical characteristic of the engine includes the further step of measuring a physical characteristic associated with each cylinder of the multi-cylinder internal combustion engine. This includes, in certain embodiments of the invention, the further step of measuring a top dead center characteristic of each such cylinder. In addition, the angular relationship between the cam shaft and the crankshaft is measured.

In a further embodiment of the invention, the step of storing data in a computer includes the further step of storing air-fuel data for determining an air: fuel ratio for each cylinder of the multi-cylinder internal combustion engine. This will, in certain embodiments, include the measurement of injector fuel flow as a function of crankshaft angle of rotation for each cylinder. There is additionally stored fuel injection timing data corresponding to a duration of a fuel injection interval for each cylinder of the multi-cylinder internal combustion engine. The determination of the fuel injection interval includes, in certain embodiments of the invention, the storage of fuel injection timing data corresponding to a start time and/or end time of a fuel injection interval for each cylinder of the multi-cylinder internal combustion engine. Data is additionally received corresponding to a timing of an injector sensor-timing signal. In addition, the start time of a fuel injection interval is determined in some embodiments to correspond to an average start time of the fuel injection interval for the plurality of cylinders of the internal combustion engine.

The correlation between the top dead center position of a piston is determined in relation to angular displacement of the crankshaft. Other relevant physical characteristics of the piston that may in certain embodiments be determined in relation to top dead center include the length of a connector assembly between the piston and the crankshaft, the distance between the top of the piston and the top of the corresponding cylinder, the angular characteristic of the crankshaft, the angular relationship between a longitudinal axis of a connecting rod pin of the crankshaft and a longitudinal axis of the crankshaft, the difference between an external diameter of a connecting rod pin of the crankshaft and an internal diameter of a connecting rod, the timing characteristic of the camshaft, and an angular characteristic of the camshaft.

In accordance with a further method aspect of the invention, there is provided a method of correcting engine performance in response to assembly deviations. The engine is an internal combustion engine of the type having an engine block with a plurality of cylindrical bores therein. A plurality of pistons accommodated within respectively associated ones of the cylindrical bores. A crankshaft, a plurality of connector assemblies for connecting respectively associated ones of the pistons to the crankshaft, a head assembly for forming a corresponding plurality of combustion chambers, and a cam shaft rotatively coupled to the crankshaft, are additionally provided. In accordance with this method aspect of the invention, there are provided the steps of:

measuring a top dead center characteristic of each piston of the internal combustion engine; and

storing data responsive to the step of measuring in a computer corresponding to each piston of the internal combustion engine.

In one embodiment of this second method aspect of the invention, the step of measuring a top dead center characteristic of each piston of the internal combustion engine includes the step of measuring a top dead center characteristic of each piston of the internal combustion engine in relation to an angular orientation of the crankshaft. As previously noted, other physical characteristics of the internal combustion engine against which the top dead center of each piston is determined include, without limitation:
a distance of axial displacement of each piston within its associated cylindrical bore;
an external diameter of a connecting rod pin of the crankshaft and an internal diameter of a connecting rod;
a timing characteristic of the camshaft;
a timing characteristic of the crankshaft;
a timing of a fuel injection interval;
a compression characteristic in each corresponding combustion chamber;
a compression value; and
a rate of change of a compression value.

In the course of engine operation, the air:fuel ratio for each piston is varied in response to the data stored during the step of measuring a top dead center characteristic of each piston of the internal combustion engine. In a further embodiment, the air:fuel ratio distribution within each combustion chamber is varied during operation of the internal combustion engine in response to the data stored in during the step of measuring a top dead center characteristic of each piston of the internal combustion engine. Other operating parameters that can be varied during engine operation include, without limitation:
a fuel injection interval start time for each piston;
a fuel injection interval end time for each piston;
the duration of a fuel injection interval for each piston;
the timing of a fuel injection interval for each piston during operation of the internal combustion engine in response to the compression value of the associated combustion chamber.
the timing of a fuel injection interval for each piston during operation of the internal combustion engine in response to the rate of change of the compression value of the associated combustion chamber.

In accordance with an apparatus aspect of the invention, there is provided an internal combustion engine of the type having:
an engine block with a plurality of cylindrical bores therein;
a plurality of pistons accommodated within respectively associated ones of the cylindrical bores;
a crankshaft having a plurality of crankshaft connector pins;
a plurality of connector assemblies for connecting respectively associated ones of the pistons to respectively associated connector pins of the crankshaft;
a head assembly for forming a corresponding plurality of respectively associated combustion chambers; and
a cam shaft rotatively coupled to the crankshaft, the cam shaft having a plurality of lobes each associated with a respective one of the combustion chambers.

Each cylindrical bore with an associated piston, a crankshaft connector pin, a combustion chamber, and a cam shaft lobe constitutes an engine cylinder. The internal combustion engine is provided with a computer having a memory for storing data responsive to the physical characteristics of each cylinder.

In one embodiment of this apparatus aspect of the invention, the data that is responsive to the physical characteristics of each cylinder includes engine control parameters for controlling predetermined operating criteria of each cylinder of the internal combustion engine during operation.

In accordance with a further apparatus aspect of the invention, there is provided an arrangement for generating data for an engine control module. The arrangement is provided with a first measurement arrangement for measuring axial displacement of a piston under test within the respectively associated one of the cylindrical bores and producing corresponding piston displacement data. There is additionally provided a second measurement arrangement for measuring radial displacement of a cam lobe associated with the piston under test and producing corresponding cam lobe displacement data. A control system receives the piston displacement data and the cam lobe displacement data and converts the piston displacement data and the cam lobe displacement data into respective engine control parameters.

In one embodiment of this further apparatus aspect of the invention, there is provided an injector data input for receiving data corresponding to the timing of injector pulses. In addition, there is provided a crankshaft data input for receiving data corresponding to the timing of the crankshaft throw. An engine control module burner arrangement is used to install engine control data corresponding to the engine control parameters into a memory location of the engine control module. The information is made available for viewing by a human operator by a display. The display presents to the human operator information corresponding to the piston displacement data, the cam lobe displacement data, and the engine control data. There is further provided in the control system a data storage location for storing limit data for determining whether the engine control parameters signify an engine condition that is out of tolerance. Such an out of tolerance engine is returned for reconstruction, as it contains characteristics for which correction is not available using the ECM.

It is an advantageous characteristic of the present system for measuring and offsetting variables in electronic injection engines that precise acquisition of engine-manufacturing variables is reduced to data that is downloaded to create proper corrective offsets to the engine control module. These offsets can result in increased power, decreased emissions, better mileage, smoother running engines, and less costly components.

As noted herein, a key point of measurement is individual cylinder top dead center. An accurate measurement of individual top dead center will allow fuel injection timing to be corrected to each cylinder. This will result in an overall increase in engine performance. The main component that can create variables in top dead center is crankshaft “connecting rod pin” angular variation.

A second point of measurement is piston to deck height at top dead center. Variations in this dimension will result in differences of effective static compression ratios from cylinder to cylinder. This variation will be shown as uneven contributed power, resulting in rough idle. This can be corrected by an offset adjusting the amount of fuel and timing injected by each injector. This correction can be offset at idle and throughout the power range. The components creating this variable are crankshaft connecting rod pin location from center of rotation, crankshaft connecting rod pin diameter, connecting rod crank pin bore diameter, connecting rod bearing clearances, connecting rod pin bore center-distances, and piston head to wrist pin bore dimension variation.

A third point of measurement is valve cam timing relative to top dead center. In most engines, the cam is mechanically driven and timing is generally not adjustable. Therefore, it is important that cam position be accurately checked in a dynamic condition to verify proper valve timing. This will maintain minimum emissions with maximum power. An incorrect cam position can be found early in the engine build process thus allowing easy replacement if required.

Valve timing is affected by the crankshaft key position relative to the crankshaft connecting rod pins, crankshaft gear key slot to crankshaft gear teeth position, backlash in the crank gear to camshaft gear drive train, camshaft gear teeth to camshaft gear key slot position and camshaft key slot to cam lobe position.

A fourth point of measurement is the injector sensor-timing signal. This sensor normally detects camshaft, or crankshaft positions and triggers the start of injector pulses. An error in this signal can cause improper injector timing resulting in increased emissions, lower performance and decreased engine efficiency.

The main components that create this variability are improper spacing of the timing sensor to the rotating mechanical trigger, improper radial spacing of the mechanical trigger elements, and weak timing sensor output signal.

A fifth point of measurement is liner height to piston head profile. Variation in this dimension can create excessive crevice volume, resulting in high emissions.

The main components that create this variability are liner shoulder to top of liner height, liner shoulder pocket depth in the cylinder block, piston, rod and crankshaft manufacturing variations. These conditions can be found early in the engine build process, thus allowing easy replacement if required.

All of these variations can be detected at one point early in the assembly process. Either “offset correction” data can be transferred to the engine control module programming point (to adjust operating parameters) or if components are too far out of adjustment, they can be replaced without major tear down of the engine.

The present invention contemplates a station in the assembly plant that is a compact, relatively light device that relies on high force magnetic clamps to retain it to the engine being tested. Unclamping and demagnetizing of the engine is performed simultaneously. The demagnetizing generally results in less residual magnetism than what are present in the engine when entering the test device.

In response to the data from the system the Engine Control Module will cause a corresponding variation in the:
amount of fuel flow per predetermined crankshaft angle of rotation on a per cylinder basis;
starting point in the engine cycle of fuel injection on a per cylinder basis;
ending point in the engine cycle of fuel injection on a per cylinder basis; and
over all timing on average for all cylinders.

An advanced embodiment of the invention is applied to control multiple injector systems per cylinder. Each such injector can have an associated injector characteristic, such as a predetermined rate of fuel flow as a function of fuel pressure, or directionality of fuel flow within the combustion chamber. In an embodiment of the invention where plural injectors are installed for each combustion chamber, the respective timing of the fuel flow interval for each such injector will result in a customized air:fuel environment within the combustion chamber. This may include, for example, a predetermined air:fuel distribution within the combustion chamber, such as stratification or compensation for crevice volume.

### BRIEF DESCRIPTION OF THE DRAWINGS

Comprehension of the invention is facilitated by reading the following detailed description, in conjunction with the annexed drawing, in which:

FIG. 1 is a graphical representation showing various engine characteristics on a common angular displacement scale;

FIG. 2 is a simplified schematic representation of an arrangement that measures the displacement of a piston with respect to an engine block;

FIG. 3 is a simplified schematic representation of an arrangement that measures the displacement of the surface of a cam lobe; and

FIG. 4 is a block and line representation partially in flowchart form that is useful in describing a simplified method aspect of the invention.

### DETAILED DESCRIPTION

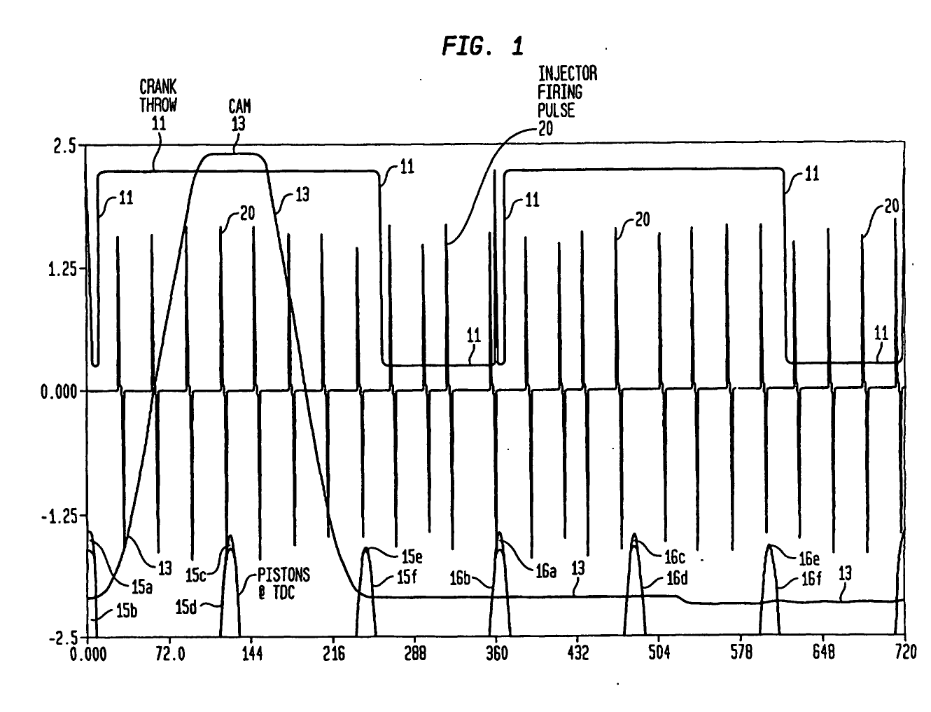

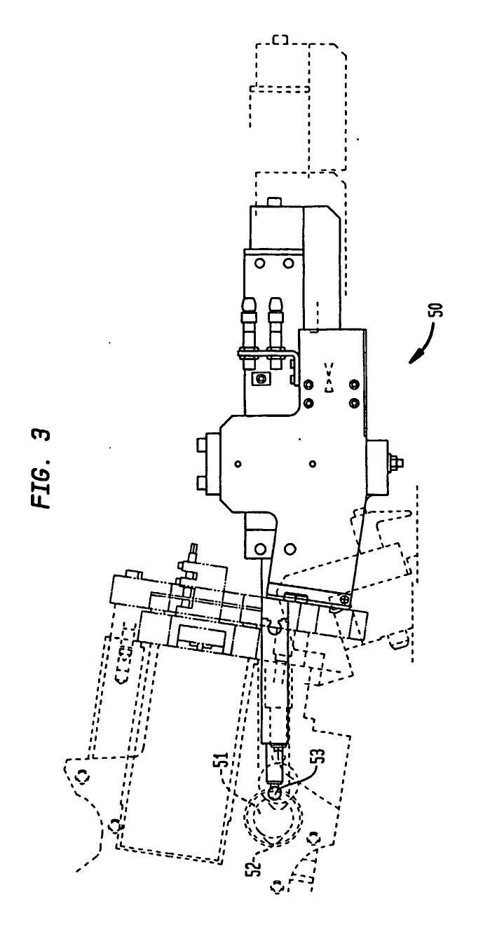

FIG. 1 is a graphical representation showing various engine characteristics on a common scale of angular displacement. The vertical axis is not specifically dimensioned. The horizontal axis is dimensioned in degrees of rotation, in this example, representing a rotational traversal of the engine (not shown) crankshaft (not shown) of 720°, which corresponds to completion of all engine cycles. The graphical plot labeled “Crank Throw” and designated as crank throw signal 11 illustrates in the vertical at 0° and at 360° the position of the engine crankshaft (not shown) relative to all other measurements. As shown, the graphical plot labeled “Cam” and designated as cam signal 13 is in the form of a lobe related to a fuel pump (not shown) that verifies the actual degree of offset the engine cam (not shown) relative to the crankshaft (not shown). In this specific illustrative embodiment of the invention, cam signal 13 corresponds to the rotation of a single cam lobe, illustratively the first cam lobe (not shown) of the cam shaft. The manner by which this signal is obtained will be discussed in relation to FIG. 3, which is a schematic representation of an apparatus for determining cam lobe surface displacement.

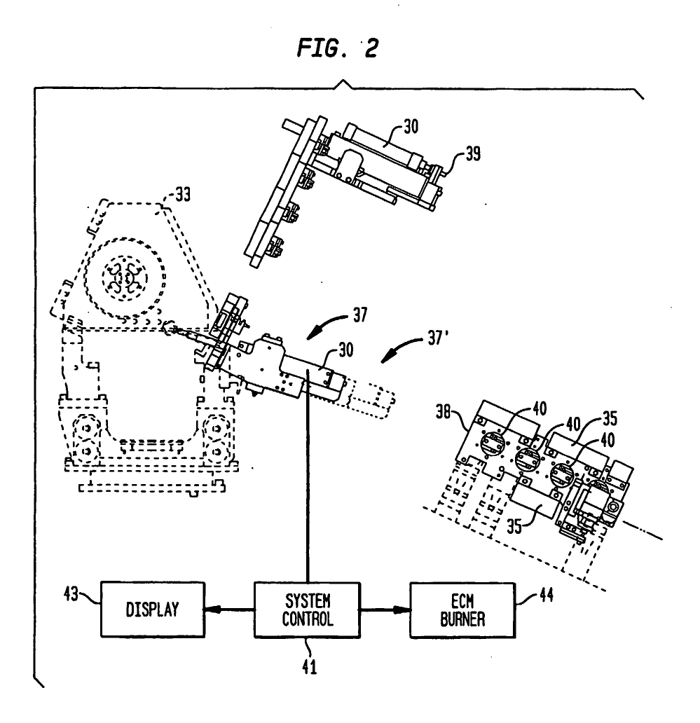

The graphically plotted lobes labeled “Pistons @ top dead center” at the bottom of the FIG. 1 that are labeled in the figure as piston signals 15a through 15f, and 16a through 16f, each correspond to the axial displacement of two pistons (not shown in this figure) reaching top dead center, the signals corresponding to the respective pairs of pistons being superimposed on one other. More particularly, the specific illustrative embodiment of the invention herein described is shown to be applied to a six cylinder Diesel engine (not shown in this figure) of the type wherein six pistons (not shown), which are designated for present purposes as pistons A through F, reach top dead center in simultaneous pairs (i.e., piston pairs A,B; C,D; and E,F). The axial displacement of each cylinder is herein represented during the first half of the cycle by a respective one of signals 15a through 15f, and during the second half of the cycle by a respective one of signals 16a through 16f. Accordingly, signals 15a and 16a represent the axial displacement of a piston A during respective halves of the engine cycle, signals 15b and 16b represent the axial displacement of piston B during respective halves of the engine cycle, signals 15c and 16c represent the axial displacement of piston C during respective halves of the engine cycle, and so forth. The manner by which these piston displacement signals is obtained will be discussed in relation to FIG. 2, which is a schematic representation of an apparatus for determining the extent of displacement for each of the six pistons.

It can be seen from piston signals 15a and 15b (as well as 16a and 16b) that piston A will at top dead center extend further into the firing chamber than piston B. Similarly, it is seen from signals 15c and 15d (as well as 16c and 16d) that piston C will at top dead center extend further into the firing chamber than piston D. From signals 15e and 15f (as well as 16e and 16f) it is seen that pistons E and F rise to about the same extent at top dead center. All of this information is valuable to the implementation of corrective strategies that may, in accordance with the invention, be implemented on a cylinder-by-cylinder basis. For example, it is possible that pistons A and/or C penetrate the firing chamber to an extent that will result in the creation of crevice volume and/or elevated compression. The corrective strategies may involve variations in the related injector firing timing, control over the fuel ratio, etc. Conversely, pistons B and/or D do not extend as deeply into the firing chamber, and therefore may represent a condition of reduced compression. Therefore, different correction strategies may be required for these pistons from those implemented in regard of pistons A and/or C.

The figure additionally shows pulses labeled “injector firing pulse” and designated as a train of injector pulses 20 that correspond to a string of trigger pulses which in normal engine operation modes are sent by a sensor to instruct the ECM (not shown) to cause the Diesel fuel injectors (not shown) to fire. In most commercial Diesel engines, injector pulses 20 are timed in response to timing marks on the cam shaft, crank shaft, or slave gear (not shown). It is nevertheless seen in FIG. 1 that injector pulses 20 are not necessarily evenly spaced during the angular engine cycle. Again, corrective information in the form of firing data can be stored in the ECM. For example, and without limitation, a predetermined pre-top dead center angular value for initiating injector firing may be stored in the system controller and in the ECM (see, FIG. 2), and corrective values can be added thereto to establish a respective optimum injector firing angle for each of the engine cylinders in response to the measurements obtained by operation of the inventive system herein described.

Using careful analysis it becomes evident that some pistons (e.g., A and C) rise higher than others. The piston lobes (15e and 15f) at approximately 230° show near perfect piston top dead centers. The other examples show some pistons that are coming too high and some too low. This causes crevice volume problems and effective compression ratio errors. Without a modified injection strategy from the ECM, these conditions will produce higher emissions and reduced engine performance. One strategy for effecting correction of the ill effects of crevice volume is to employ a multiple injector arrangement, as discussed herein, whereby the air:fuel environment within the combustion chamber is customized so as to control the air: fuel mixture in the crevice volume. In one embodiment, the multiple injectors are individually controlled.

Of greater significance is the fact that the train of injector firing pulses 20 shows a slightly advanced location at approximately 120° and a trigger point that is severely advanced at approximately 480°. This will cause significant emission of pollutants from the engine and performance problems. An important aspect of this invention is that the above data and other engine information will automatically be reduced to a set of parameters that are intelligible to the ECM, and then the information is transmitted to a point on the assembly line where it can embed or “burn-in” electronic correction strategies on a cylinder-by-cylinder basis in response to the mechanical deficiencies that have been measured in the engine. As noted, these corrections relate to injection timing, injection pressure, injection quantity and shape, and other strategies for achieving cleaner and more efficient combustion.

FIG. 2 is a simplified schematic representation of an arrangement that measures the displacement of a cam lobe (not shown in this figure) and a piston (not shown in this figure) with respect to an engine block, and which shows top and side representations of a measurement probe 30. As shown in this figure, measurement probe 30 is disposed in the vicinity of a Diesel engine block 33 that is, in this specific illustrative embodiment of the invention, maintained in fixed spatial relation by operation of a magnetic clamping assembly 35. Measurement probe 30, however, is displaceable between a position 37 (shown in solid line format) and a position 37′ (shown in phantom). Within measurement probe 30 there is provided a linear voltage differential transformer (LVDT) device (not shown) that produces an electrical data signal responsive to the displacement that is sensed at measurement point 39. There is additionally provided a measurement head 38 that is provided with a measurement probe 40 for each piston. Measurement probe 40 is configured to wobble slightly to compensate for the piston not being precisely parallel to the cylinder axis. Thus, the average protrusion of the piston at top dead center is determined.

FIG. 2 additionally shows that the data signal from the LVDT is delivered to a system control unit 41. The data is then presented on a display 43, illustratively in the form of the graphical representation of FIG. 1, and the electronic correction strategies then are incorporated into the ECM at ECM burner 44.

FIG. 3 is a simplified schematic representation of a measurement arrangement 50 that directs a probe tip 53 toward a cam 51. Probe tip 53 measures the displacement of the surface of a cam lobe 52 of cam 51 of the Diesel engine (not specifically designated in this figure). The data signal from a LVDT (not shown) is delivered to system control unit 41 (FIG. 2) for presentation on display 43 as cam signal 13, as previously described in relation to FIG. 1.

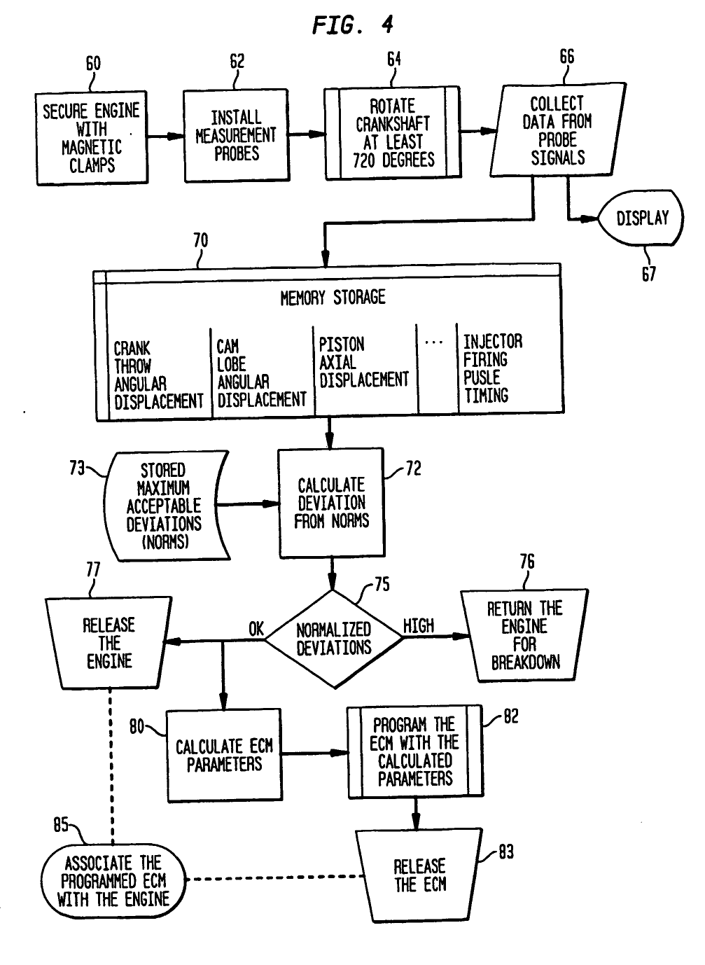

FIG. 4 is a block and line representation partially in flowchart form that is useful in describing a simplified method aspect of the invention. As shown in this figure, The process of the specific illustrative embodiment of the invention begins with the securing of the engine at function block 60 to a fixed structure, illustratively using magnetic clamps (not shown). Measurement probes (not shown in this figure) are then installed at function block 62. These include, for example, probes for measuring the radial displacement of a lobe of the cam shaft (see, e.g., FIG. 3), a probe for measuring the axial displacement of a piston (not shown) within a cylinder bore, and a probe for measuring the throw of the crank shaft (not shown). In order to obtain the data throughout the four cycles of the internal combustion engine, the crankshaft (not shown) is rotated for a minimum of 720 degrees at function block 64. During such rotation of the crankshaft, the data from the various probes is collected at function block 66. This information may, in certain embodiments of the invention, be displayed (see, e.g., FIG. 1) at function block 67.

The collected data, which may include in certain embodiments, without limitation, data corresponding to crank throw angular displacement, cam lobe angular displacement, piston axial displacement, and injector firing pulse timing, is stored in memory storage 70. In this specific illustrative embodiment of the invention, the data stored in memory 70 is compared at function block 72 against data norms that are pre-stored in a memory 73. The deviation, or difference, between the collected data and the stored normal data is considered at decision function block 75. if the difference is greater than permissible, then the engine is determined to be too far out of tolerance to be corrected by the engine control module, and therefore the engine is returned for breakdown and reassembly at function block 76.

If the engine is determined to be within tolerances, then it is released at function block 77. In addition, the ECM parameters are calculated for each cylinder of the engine at function block 80 and the resulting parameters are programmed into the ECM at function block 82. The programmed ECM is released at function block 83 and is associated with the corresponding engine at function block 85, as the data programmed into the ECM is specific to the physical characteristics of each cylinder of that engine.

Although the invention has been described in terms of specific embodiments and applications, persons skilled in the art may, in light of this teaching, generate additional embodiments without exceeding the scope or departing from the spirit of the claimed invention. Accordingly, it is to be understood that the drawing and description in this disclosure are proffered to facilitate comprehension of the invention, and should not be construed to limit the scope thereof.

What is claimed is:

1. A method of correcting engine performance in response to assembly deviations, the method comprising the steps of:
measuring a physical characteristic of the engine; and
storing data responsive to said step of measuring in a computer.

2. The method of claim 1, wherein there is further provided the step of operating the engine in response to the stored data.

3. The method of claim 1, wherein the stored data corresponds to deviation information responsive to deviation of a physical characteristic of the engine from a determined norm.

4. The method of claim 3, wherein there is further provided the step of varying an operating characteristic of the engine during operation in response to the deviation information.

5. The method of claim 1, wherein the engine is an internal combustion engine having a plurality of cylinders, the computer is an engine control module, and the stored data has a plurality of data portions corresponding to the physical characteristics of respectively corresponding ones of the cylinders, and there is further provided the step of operating each of the plurality of cylinders of the internal combustion engine in response to the respectively corresponding portions of the stored data.

6. The method of claim 1, wherein the engine is an internal combustion engine having a plurality of cylinders, a crankshaft rotatively coupled to a corresponding plurality of pistons, and a cam shaft coupled to the crankshaft for operating a valve, and said step of measuring a physical characteristic of the engine comprises the further step of measuring a physical characteristic associated with each cylinder of the multi-cylinder internal combustion engine.

7. The method of claim 6, wherein said step of measuring a physical characteristic associated with each cylinder of the multi-cylinder internal combustion engine comprises the further step of measuring a rate of injector fuel flow for each cylinder of the multi-cylinder internal combustion engine as a function of angle of crankshaft rotation.

8. The method of claim 6, wherein said step of measuring a physical characteristic associated with each cylinder of the multi-cylinder internal combustion engine comprises the further step of measuring a top dead center characteristic of each such cylinder.

9. The method of claim 6, wherein said step of measuring a physical characteristic associated with each cylinder of the multi-cylinder internal combustion engine comprises the further step of measuring an angular relationship between the cam shaft and the crankshaft.

10. The method of claim 8, wherein said step of storing data in a computer comprises the further step of storing air-fuel data for determining an air:fuel ratio for each cylinder of the multi-cylinder internal combustion engine.

11. The method of claim 8, wherein said step of storing data in a computer comprises the further step of storing fuel injection timing data corresponding to a duration of a fuel injection interval for each cylinder of the multi-cylinder internal combustion engine.

12. The method of claim 8, wherein said step of storing data in a computer comprises the further step of storing fuel injection timing data corresponding to a start time of a fuel injection interval for each cylinder of the multi-cylinder internal combustion engine.

13. The method of claim 12, wherein said step of storing fuel injection timing data corresponding to a start time of a fuel injection interval for each cylinder of the multi-cylinder internal combustion engine comprises the further step of storing data responsive to a timing of top dead center for each cylinder, the start time of the fuel injection interval for each cylinder of the multi-cylinder internal combustion engine being determined in relation to the top dead center of the associated piston.

14. The method of claim 12, wherein said step of storing fuel injection timing data corresponding to a start time of a fuel injection interval for each cylinder of the multi-cylinder internal combustion engine comprises the further step of storing data responsive to a timing of an injector sensor-timing signal.

15. The method of claim 8, wherein said step of storing fuel injection timing data corresponding to a start time of a fuel injection interval corresponds to an average start time of the fuel injection interval for the plurality of cylinders of the internal combustion engine.

16. The method of claim 8, wherein said step of storing data in a computer comprises the further step of storing fuel injection timing data corresponding to an end time of a fuel injection interval for each cylinder of the multi-cylinder internal combustion engine.

17. The method of claim 8, wherein said step of measuring a top dead center characteristic of each such cylinder comprises the further step of measuring a top dead center characteristic of each such cylinder in response to angular displacement of the crankshaft.

18. The method of claim 8, wherein said step of measuring a top dead center characteristic of each such cylinder comprises the further step of measuring a top dead center characteristic of each such cylinder in response to a length a connector assembly between the piston and the crankshaft.

19. The method of claim 8, wherein said step of measuring a top dead center characteristic of each such cylinder comprises the further step of measuring a top dead center characteristic of each such cylinder in response to a distance between the top of the piston and the top of the corresponding cylinder.

20. The method of claim 8, wherein the top dead center characteristic corresponds to an angular characteristic of the crankshaft.

21. The method of claim 20, wherein the angular characteristic of the crankshaft corresponds to an angular relationship between a longitudinal axis of a connecting rod pin of the crankshaft and a longitudinal axis of the crankshaft.

22. The method of claim 20, wherein the top dead center characteristic is responsive to a difference between an external diameter of a connecting rod pin of the crankshaft and an internal diameter of a connecting rod.

23. The method of claim 8, wherein said step of measuring a top dead center characteristic of each such cylinder comprises the further step of measuring a top dead center characteristic of each such cylinder in response to a timing characteristic of the cam shaft.

24. The method of claim 8, wherein said step of measuring a top dead center characteristic of each such cylinder comprises the further step of measuring a top dead center characteristic of each such cylinder in response to an angular characteristic of the cam shaft.

25. A method of correcting engine performance in response to assembly deviations, the engine being an internal combustion engine of the type having an engine block with a plurality of cylindrical bores therein, a plurality of pistons accommodated within respectively associated ones of the cylindrical bores, a crankshaft, a plurality of connector assemblies for connecting respectively associated ones of the pistons to the crankshaft, a head assembly for forming a corresponding plurality of combustion chambers, and a cam shaft rotatively coupled to the crankshaft, the method comprising the steps of:
measuring a top dead center characteristic of each piston of the internal combustion engine; and
storing data responsive to said step of measuring in a computer corresponding to each piston of the internal combustion engine.

26. The method of claim 25, wherein the data stored in said step of storing corresponds to the rate of injector fuel flow corresponding to each piston of the internal combustion engine as a function of crankshaft angle.

27. The method of claim 25, wherein said step of measuring a top dead center characteristic of each piston of the internal combustion engine comprises the step of measuring a top dead center characteristic of each piston of the internal combustion engine in relation to an angular orientation of the crankshaft.

28. The method of claim 25, wherein said step of measuring a top dead center characteristic of each piston of the internal combustion engine comprises the step of measuring a top dead center characteristic of each piston of the internal combustion engine in relation to a distance of axial displacement of each piston within its associated cylindrical bore.

29. The method of claim 25, wherein said step of measuring a top dead center characteristic of each piston of the internal combustion engine comprises the step of measuring a top dead center characteristic of each piston of the internal combustion engine in relation to a difference between an external diameter of a connecting rod pin of the crankshaft and an internal diameter of a connecting rod.

30. The method of claim 25, wherein said step of measuring a top dead center characteristic of each piston of the internal combustion engine comprises the step of measuring a top dead center characteristic of each piston of the internal combustion engine in relation to a timing characteristic of the cam shaft.

31. The method of claim 25, wherein said step of measuring a top dead center characteristic of each piston of the internal combustion engine comprises the step of measuring a top dead center characteristic of each piston of the internal combustion engine in relation to a timing of a fuel injection interval.

32. The method of claim 25, wherein said step of measuring a top dead center characteristic of each piston of the internal combustion engine comprises the step of measuring a top dead center characteristic of each piston of the internal combustion engine in relation to a compression characteristic in each corresponding combustion chamber.

33. The method of claim 32, wherein the compression characteristic in each corresponding combustion chamber corresponds to a compression value.

34. The method of claim 32, wherein the compression characteristic in each corresponding combustion chamber corresponds to a rate of change of a compression value.

35. The method of claim 25, wherein there is provided the further step of varying an air:fuel ratio for each piston during operation of the internal combustion engine in response to the data stored in response to said step of measuring a top dead center characteristic of each piston of the internal combustion engine.

36. The method of claim 25, wherein there is provided the further step of varying an air:fuel ratio distribution for each combustion chamber during operation of the internal combustion engine in response to the data stored in response to said step of measuring a top dead center characteristic of each piston of the internal combustion engine.

37. The method of claim 25, wherein there is provided the further step of varying a fuel injection interval start time for each piston during operation of the internal combustion engine in response to the data stored in response to said step of measuring a top dead center characteristic of each piston of the internal combustion engine.

38. The method of claim 25, wherein there is provided the further step of varying a fuel injection interval end time for each piston during operation of the internal combustion engine in response to the data stored in response to said step of measuring a top dead center characteristic of each piston of the internal combustion engine.

39. The method of claim 25, wherein there is provided the further step of varying the duration of a fuel injection interval for each piston during operation of the internal combustion engine in response to the data stored in response to said step of measuring a top dead center characteristic of each piston of the internal combustion engine.

40. The method of claim 25, wherein there is provided the further step of varying the timing of a fuel injection interval for each piston during operation of the internal combustion engine in response to the compression value of the associated combustion chamber.

41. The method of claim 25, wherein there is provided the further step of varying the timing of a fuel injection interval for each piston during operation of the internal combustion engine in response to the rate of change of the compression value of the associated combustion chamber.

42. An internal combustion engine of the type having an engine block with a plurality of cylindrical bores therein, a plurality of pistons accommodated within respectively associated ones of the cylindrical bores, a crankshaft having a plurality of crankshaft connector pins, a plurality of connector assemblies for connecting respectively associated ones of the pistons to respectively associated connector pins of the crankshaft, a head assembly for forming a corresponding plurality of respectively associated combustion chambers, and a cam shaft rotatively coupled to the crankshaft, the cam shaft having a plurality of lobes each associated with a respective one of the combustion chambers, each cylindrical bore with associated piston, crankshaft connector pin, combustion chamber, and cam shaft lobe constituting a cylinder, the internal combustion engine comprising a computer having a memory for storing data responsive to the physical characteristics of each cylinder.

43. The internal combustion engine of claim 42, wherein the data responsive to the physical characteristics of each cylinder comprises engine control parameters for controlling predetermined operating criteria of each cylinder of the internal combustion engine during operation.

44. An arrangement for generating data for an engine control module, the arrangement comprising:
a first measurement arrangement for measuring axial displacement of a piston under test within the respectively associated one of the cylindrical bores and producing corresponding piston displacement data;
a second measurement arrangement for measuring radial displacement of a cam lobe associated with the piston under test and producing corresponding cam lobe displacement data; and
a control system for receiving the piston displacement data and the cam lobe displacement data and converting the piston displacement data and the cam lobe displacement data into respective engine control parameters.

45. The arrangement of claim 44, wherein there is further provided an injector data input for receiving data corresponding to the timing of injector pulses.

46. The arrangement of claim 44, wherein there is further provided a crankshaft data input for receiving data corresponding to the timing of the crankshaft throw.

47. The arrangement of claim 44, wherein there is further provided an engine control module burner arrangement for installing engine control data corresponding to the engine control parameters into a memory location of the engine control module.

48. The arrangement of claim 47, wherein there is further provided a display for displaying to a human operator information corresponding to the piston displacement data, the cam lobe displacement data, and the engine control data.

49. The arrangement of claim 47, wherein there is further provided in said control system a data storage location for storing limit data for determining whether the engine control parameters signify an engine condition that is out of tolerance.
